(19) United States
(12) Patent Application Publication
(10) Pub. No.: US 2023/0102722 A1
(43) Pub. Date: Mar. 30, 2023

(54) PROCESSES FOR PRODUCING FILLED POLYOL COMPOSITIONS

(71) Applicant: Covestro LLC, Pittsburgh, PA (US)

(72) Inventors: Rick L. Adkins, Canonsburg, PA (US); Brian L. Neal, Pittsburgh, PA (US); Bin Lee, Coraopolis, PA (US)

(21) Appl. No.: 17/463,945

(22) Filed: Sep. 1, 2021

(51) Int. Cl. C08J 9/00; C08F 212/10; C08L 71/02; C08G 18/48; C08G 18/76; C08G 18/71; C08G 18/22; C08J 9/04

(52) U.S. Cl. CPC C08J 9/0061; C08F 212/10; C08L 71/02; C08G 18/4845; C08G 18/7671; C08G 18/71; C08G 18/227; C08J 9/04; C08F 2438/02; C08J 2375/08; C08J 2425/12

(57) ABSTRACT

Processes for producing filled polyol compositions, such as polymer polyol compositions. The processes include reacting a polymerizable composition in the presence of a composition comprising a base polyol and an amine antioxidant, in which the amine antioxidant comprises a secondary diarylamine, a primary aromatic amide, a triazole, or a combination thereof.

### FIELD

This specification pertains generally to processes for producing filled polyol, such as polymer polyol, compositions that include an amine antioxidant, as well as to the use of such filled polyol compositions in the production of flexible polyurethane foams.

### BACKGROUND

Filled polyols are dispersions of polymer particles in a base polyol. They can be particularly suitable for preparing foams with higher hardness levels than a conventional, unmodified, polyol can produce, and are often used in the production of flexible polyurethane foams by reacting the polyol with a polyisocyanate in the presence of a blowing agent and other ingredients, such as catalyst, surfactant and antioxidant. In many cases, the polyol is a polyether polyol that is an alkoxylation reaction product of one or more H-functional starters and one or more alkylene oxides. Often, due to the hydrophobic quality produced in the resulting polyether polyol, propylene oxide is the primary or sole alkylene oxide employed.

One drawback of polyether polyols, particular those produced using propylene oxide as the alkylene oxide, is that they can be susceptible to thermal oxidative degradation, which can produce a variety of volatile organic compounds (VOCs), such as formaldehyde and acetaldehyde. As a result, antioxidants (AOs) are often used to reduce the thermal oxidative degradation of polyether polyols. Aminic antioxidants are sometimes used and can be very effective at reducing VOC emissions in polyurethane foam raw materials, such as polyols, and polyurethane foams.

One challenge in the production of filled polyols, particularly those of desirably high solids content, is viscosity. The viscosity of a filled polyol should be sufficiently low for ease of handling during its manufacture. In addition, the viscosity should facilitate transport, handling and, ultimately, adequate processability, in the employed foam processing equipment. Because of increased use of sophisticated mixing systems, such as impingement systems, excessive viscosity of the polymer polyol can be a significant problem.

As a result, it would be desirable to provide a means for reducing the viscosity of filled polyols that include an amine antioxidant.

### SUMMARY

In certain respects, this specification relates to processes for producing filled polyol compositions comprising a dispersion of polymer particles in a base polyol. The processes comprise reacting a polymerizable composition in the presence of a composition comprising a base polyol and an amine antioxidant, in which the amine antioxidant comprises a secondary diarylamine, a primary aromatic amide, a triazole, or a combination thereof

In other respects, this specification relates to processes for preparing a filled polyol comprising free-radically polymerizing a reaction mixture comprising: (a) a base polyol having a functionality of from about 2 to about 8 and a hydroxyl number of from about 10 to about 1000 mg KOH/g; (b) an amine antioxidant comprising a secondary diarylamine, a primary aromatic amide, a triazole, or a combination thereof; (c) at least one preformed stabilizer; (d) an ethylenically unsaturated monomer; (e) a free radical polymerization catalyst and, optionally (f) a polymer control agent.

In other respects, this specification relates to filled polyol compositions produced by such processes, polyurethane foam-forming compositions that include such filled polyols, and to polyurethane foams produced from such foam-forming compositions.

### DETAILED DESCRIPTION

Various implementations are described and illustrated in this specification to provide an overall understanding of the structure, function, properties, and use of the disclosed inventions. It is understood that the various implementations described and illustrated in this specification are non-limiting and non-exhaustive. Thus, the invention is not limited by the description of the various non-limiting and non-exhaustive implementations disclosed in this specification. The features and characteristics described in connection with various implementations may be combined with the features and characteristics of other implementations. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132(a). The various implementations disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described implementations. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of the —OH functional material that is being described. In the production of polyurethane foams, the hydroxyl groups react with isocyanate groups, —NCO, that are attached to the isocyanate compound. The term “hydroxyl number” or “OH number” refers to the number of reactive hydroxyl groups available for reaction, and is expressed as the number of milligrams of potassium hydroxide equivalent to the hydroxyl content of one gram of the polyol (ASTM D4274-16). The term “equivalent weight” refers to the weight of a compound divided by its valence. For a polyol, the equivalent weight is the weight of the polyol that will combine with an isocyanate group, and may be calculated by dividing the molecular weight of the polyol by its functionality. The equivalent weight of a polyol may also be calculated by dividing 56,100 by the hydroxyl number of the polyol−Equivalent Weight (g/eq)=(56.1×1000)/OH number.

As used herein, “monomer” means the simple unpolymerized form of a chemical compound having relatively low molecular weight, e.g., acrylonitrile, styrene, methyl methacrylate, and the like.

As used herein, “polymerizable ethylenically unsaturated compound” means a compound containing ethylenic unsaturation (C═C, i.e., two double bonded carbon atoms) that is capable of undergoing free radically induced addition polymerization reactions.

As used herein, “pre-formed stabilizer” means an intermediate obtained by reacting a macromer containing reactive unsaturation (e.g. acrylate, methacrylate, maleate, etc.) with one or more monomers (i.e. acrylonitrile, styrene, methyl methacrylate, etc.), with and at least one free radical initiator, in the presence of a polymer control agent (PCA) and, optionally, in a diluent, to give a co-polymer (i.e. a dispersion having e.g. a low solids content (e.g. <30%), or soluble grafts, etc.).

As used herein “viscosity” is in millipascal-seconds (mPas) measured at 25° C. on an Anton Paar SVM3000 viscometer.

As indicated, certain implementations of the present specification are directed to filled polyol compositions comprise a dispersion of polymer particles in a polyol. In some embodiments, the filled polyol composition are characterized by a solids content, i.e., content of polymer particles, of 30% by weight to 75% by weight, such as 35% by weight to 70% by weight, 40% by weight to 60% by weight, or 45% by weight to 55% by weight, based on the total weight of the filled polyol composition. Moreover, in some implementations, the filled polyol composition has a viscosity (as defined above) of less than 50,000 mPas, less than 40,000 mPas, less than 30,000 mPas, less than 20,000 mPas or, in some cases, less than 10,000 mPas.

In some embodiments, the polymer particles comprise a polymer comprising the free radical polymerization reaction product of an ethylenically unsaturated compound. These implementations of the filled polyol composition may be referred to herein as a “polymer polyol”. More particularly, in some of these embodiments, the filled polyol composition comprises a reaction product of a reaction mixture comprising: (a) a base polyol having a functionality of 2 to 8 and a hydroxyl number of 20 to 400; (b) an ethylenically unsaturated compound, (c) a preformed stabilizer, and (d) a free radical initiator.

Suitable base polyols include, for example, polyether polyols having a functionality of 2 to 8, such as 2 to 6 or 3 to 6, and an OH number of 20 to 400 mg KOH/g, 20 to 200 mg KOH/g, 20 to 150 mg KOH/g, 20 to 100 mg KOH/g, or, in some cases, 20 to 50 mg KOH/g, 25 to 50 mg KOH/g, or 30 to 50 mg KOH/g.

Specific examples of suitable base polyols include polyoxyethylene glycols, polyoxyethylene triols, polyoxyethylene tetrols and higher functionality polyoxyethylene polyols, polyoxypropylene glycols, polyoxypropylene triols, polyoxypropylene tetrols and higher functionality polypropylene polyols, mixtures thereof When mixtures as used, the ethylene oxide and propylene oxide may be added simultaneously or sequentially to provide internal blocks, terminal blocks or random distribution of the oxyethylene groups and/or oxypropylene groups in the polyether polyol. Suitable starters or initiators for these compounds include, for example, ethylene glycol, propylene glycol, diethylene glycol, dipropylene glycol, tripropylene glycol, trimethylol-propane, glycerol, pentaerythritol, sorbitol, sucrose, ethylenediamine, toluene diamine, etc. The alkoxylation reaction may be catalyzed using any conventional catalyst including, for example, potassium hydroxide (KOH) or a double metal cyanide (DMC) catalyst.

Other suitable polyether polyols for the base polyol of the present invention include alkylene oxide adducts of non-reducing sugars and sugar derivatives, alkylene oxide adducts of phosphorus and polyphosphorus acids, alkylene oxide adducts of polyphenols, polyols prepared from natural oils such as, for example, castor oil, etc., and alkylene oxide adducts of polyhydroxyalkanes other than those described above.

Illustrative alkylene oxide adducts of polyhydroxyalkanes include, for example, alkylene oxide adducts of 1,3-dihydroxypropane, 1,3-dihydroxybutane, 1,4-dihydroxybutane, 1,4-, 1,5- and 1,6-dihydroxyhexane, 1,2-, 1,3-, 1,4-1,6- and 1,8-dihydroxyoctant, 1,10-dihydroxydecane, glycerol, 1,2,4-tirhydroxybutane, 1,2,6-trihydroxyhexane, 1,1,1-trimethyl-olethane, 1,1,1-trimethylolpropane, pentaerythritol, caprolactone, polycaprolactone, xylitol, arabitol, sorbitol, mannitol, and the like.

Other polyols which can be employed include the alkylene oxide adducts of non-reducing sugars, wherein the alkoxides have from 2 to 4 carbon atoms. Non-reducing sugars and sugar derivatives include sucrose, alkyl glycosides such as methyl glycoside and ethyl glucoside, glycol glucosides, such as ethylene glycol glycoside, propylene glycol glucoside, glycerol glucoside, and 1,2,6-hexanetriol glucoside, as well as alkylene oxide adducts of the alkyl glycosides.

Other suitable base polyols include the polyphenols, such as the alkylene oxide adducts thereof, wherein the alkylene oxides have from 2 to 4 carbon atoms. Among the polyphenols which are suitable are, for example, bisphenol A, bisphenol F, condensation products of phenol and formaldehyde, the novolac resins, condensation products of various phenolic compounds and acrolein, including the 1,1,3-tris(hydroxy-phenyl)propanes, condensation products of various phenolic compounds and glyoxal, glutaraldehyde, other dialdehydes, including the 1,1,2,2-tetrakis(hydroxyphenol)ethanes.

The alkylene oxide adducts of phosphorus and polyphosphorus acid are also suitable base polyols. These include ethylene oxide, 1,2-epoxy-propane, the epoxybutanes, 3-chloro-1,2-epoxypropane as alkylene oxides. Phosphoric acid, phosphorus acid, polyphosphoric acids, such as tripolyphosphoric acid, and the polymetaphosphoric acids are suitable for use herein.

Of course, blends or mixtures of various useful polyols may be used if desired.

Suitable ethylenically unsaturated compounds for use in the reaction mixture to produce the filled polyol composition include, for example, aliphatic conjugated dienes, such as butadiene and isoprene, monovinylidene aromatic monomers, such as styrene, α-methyl-styrene, (t-butyl)styrene, chlorostyrene, cyanostyrene and bromostyrene; α,β-ethylenically unsaturated carboxylic acids and esters thereof, such as acrylic acid, methacrylic acid, methyl methacrylate, ethyl acrylate, 2-hydroxyethyl acrylate, butyl acrylate, itaconic acid, and maleic anhydride, α,β-ethylenically unsaturated nitriles and amides, such as acrylonitrile, methacrylonitrile, acrylamide, methacrylamide, N,N-dimethyl acrylamide, and N-(dimethylaminomethyl)-acrylamide, vinyl esters, such as vinyl acetate, vinyl ethers, vinyl ketones, and vinyl and vinylidene halides, among others. Of course, mixtures of two or more of the aforementioned monomers are also suitable. In some embodiments, the ethylenically unsaturated monomer comprises at least one of styrene and its derivatives, acrylonitrile, methyl acrylate, methyl methacrylate, and vinylidene chloride.

In some embodiments, the ethylenically unsaturated compound comprises styrene and acrylonitrile. More specifically, in some implementations, styrene and acrylonitrile are used in sufficient amounts such that the weight ratio of styrene to acrylonitrile (S:AN) is within the range of 80:20 to 20:80, such as 75:25 to 25:75.

In some implementations, the pre-formed stabilizer used to produce the filled polyol composition comprises the reaction product of a reaction mixture comprising: (a) a macromer that contains reactive unsaturation, (b) an ethylenically unsaturated compound, (c) a free radical initiator, (d) a polymer control agent; and, in some cases, (e) a chain transfer agent.

In some implementations, the macromer utilized to produce the pre-formed stabilizer comprises the reaction product of a reaction mixture comprising: (i) an H-functional starter having a functionality of 2 to 8 and a hydroxyl number of 20 to 50; (ii) from 0.1 to 3% by weight, based on 100% by weight of the sum of components (i), (ii) and (iii), of a hydroxyl-reactive compound that contains reactive unsaturation; and (iii) from 0 to 3% by weight, such as 0.05 to 2.5% by weight, or 0.1 to 1.5% by weight, based on 100% by weight of the sum of components (i), (ii) and (iii), of a diisocyanate.

Suitable preformed stabilizers can be prepared by reacting a combination of components (a), (b), (c) and (d), and optionally, (e), as described above, in a reaction zone maintained at a temperature sufficient to initiate a free radical reaction, and under sufficient pressure to maintain only liquid phases in the reaction zone, for a sufficient period of time to react (a), (b) and (c); and recovering a mixture containing the preformed stabilizer dispersed in the polymer control agent.

Suitable starters for use in preparing the macromer include compounds having a hydroxyl functionality of 2 to 8, such as 3 to 6, and a hydroxyl number of 20 to 50, such as 25 to 40. A specific example of a suitable starter is an alkylene oxide adduct of a hydroxyl functional compound, such as ethylene glycol, propylene glycol, diethylene glycol, dipropylene glycol, tripropylene glycol, glycerin, trimethylolpropane, pentaerythritol, sorbitol, ethylenediamine, and toluene diamine, among others, including mixtures of any two or more thereof, in which the alkylene oxide comprises, for example, propylene oxide, ethylene oxide, butylene oxide, or styrene oxide, among others, including mixtures of any two or more thereof. When a mixture of alkylene oxides are used to form the starter, a mixture of propylene oxide and ethylene oxide may be advantageous. Such mixtures may be added simultaneously (i.e. two or more alkylene oxide are added as co-feeds to produce a substantially secondary hydroxyl terminated polyol), or sequentially (one alkylene oxide is added first, and then another alkylene oxide is added). It is possible to use a combination of simultaneous and sequential addition of alkylene oxides. In one embodiment, an alkylene oxide such as propylene oxide may be added first, and then a second alkylene oxide such as ethylene oxide added as a cap.

Other examples of suitable starters for preparing the macromer are polyoxyethylene glycols, triols, tetrols and higher functionality polyols, and mixtures thereof, as well as alkylene oxide adducts of non-reducing sugars and sugar derivatives, alkylene oxide adducts of phosphorus and polyphosphorus acids, alkylene oxide adducts of polyphenols, polyols prepared from natural oils such as, for example, castor oil, and alkylene oxide adducts of polyhydroxyalkanes other than those described above. Illustrative alkylene oxide adducts of polyhydroxyalkanes include, for example, alkylene oxide adducts of 1,3-dihydroxypropane, 1,3-dihydroxybutane, 1,4-dihydroxybutane, 1,4-, 1,5- and 1,6-dihydroxyhexane, 1,2-, 1,3-, 1,4-1,6- and 1,8-dihydroxyoctant, 1,10-dihydroxydecane, glycerol, 1,2,4-tirhydroxybutane, 1,2,6-trihydroxyhexane, 1,1,1-trimethyl-olethane, 1,1,1-trimethylolpropane, pentaerythritol, caprolactone, polycaprolactone, xylitol, arabitol, sorbitol, and mannitol. Specific examples of alkylene oxide adducts of non-reducing sugars, include those where the alkoxides have from 2 to 4 carbon atoms. Non-reducing sugars and sugar derivatives include sucrose, alkyl glycosides, such as methyl glycoside and ethyl glucoside, glycol glucosides, such as ethylene glycol, glycoside, propylene glycol glucoside, glycerol glucoside, and 1,2,6-hexanetriol glucoside, and alkylene oxide adducts of the alkyl glycosides. Other suitable polyols starters for preparing the macromer include polyphenols, such as alkylene oxide adducts thereof, wherein the alkylene oxides have from 2 to 4 carbon atoms. Suitable polyphenols include, for example bisphenol A, bisphenol F, condensation products of phenol and formaldehyde, the novolac resins, condensation products of various phenolic compounds and acrolein, including the 1,1,3-tris(hydroxy-phenyl)propanes, condensation products of various phenolic compounds and glyoxal, glutaraldehyde, other dialdehydes, including the 1,1,2,2-tetrakis (hydroxyphenol)ethanes.

In some implementations, the starter used to prepare the macromer has a functionality of from 3 to 6 and a hydroxyl number of from 25 to 40 mg KOH/g, and is prepared by reacting a starter such as glycerin, trimethylolpropane, pentaerythritol, dipentaerythritol, sorbitol, mannitol, or a mixture of any two or more thereof, with an alkylene oxide comprising at least one of propylene oxide and/or ethylene oxide. In some of these embodiments, ethylene oxide is utilized in an amount of 1 to 40% by weight, such as 5 to 30% by weight or 10 to 25% by weight, based on the total weight of the starter compound. In some embodiments, all or a portion of the ethylene oxide is added as a cap on the end of the starter compound. Suitable amounts of ethylene oxide to be added as a cap range from, for example, 1 to 40% by weight, such as 3 to 30% by weight or 5 to 25% by weight, based on the total weight of starter.

As indicated earlier, in some implementations, the reaction mixture used to produce the macromer utilized to produce the pre-formed stabilizer also comprises a hydroxyl-reactive compound that contains reactive unsaturation. Suitable such compounds include, for example, methyl methacrylate, ethyl methacrylate, maleic anhydride, isopropenyl dimethyl benzyl isocyanate, 2-isocyanatoethyl methacrylate, adducts of isophorone diisocyanate and 2-hydroxyethyl methacrylate, and adducts of toluenediisocyanate and 2-hydroxypropyl acrylate, among others, including mixtures of any two or more thereof.

As also indicated earlier, in some implementations, the reaction mixture used to produce the macromer utilized to produce the pre-formed stabilizer may also comprise a diisocyanate. Suitable diisocyanates include various isomers of diphenylmethane diisocyanate and isomeric mixtures of diphenylmethane diisocyanate, such as, for example, mixtures of 2,4′-diphenylmethane diisocyanate, 4,4′-diphenylmethane diisocyanate and/or 2,2′-diphenyl-methane diisocyanate. Other suitable isocyanates include toluenediisocyanate, isophoronediisocyanate, hexamethylenediisocyanate, and 4,4′-methylenebis(cyclohexyl isocyanate), among others, includes mixtures of any two or more thereof.

In certain implementations, the macromer is used in an amount of 10 to 40% by weight, such as 15 to 35% by weight, based on the total weight of the reaction mixture used to produce the pre-formed stabilizer.

As previously mentioned, in some implementations, the reaction mixture used to form the pre-formed stabilizer used to produce the filled polyol composition also comprises an ethylenically unsaturated compound. Suitable such ethylenically unsaturated compounds are aliphatic conjugated dienes, such as butadiene and isoprene, monovinylidene aromatic monomers such as styrene, α-methylstyrene, (t-butyl)styrene, chlorostyrene, cyanostyrene and bromostyrene, α,β-ethylenically unsaturated carboxylic acids and esters thereof, such as acrylic acid, methacrylic acid, methyl methacrylate, ethyl acrylate, 2-hydroxyethyl acrylate, butyl acrylate, itaconic acid, maleic anhydride and the like, α,β-ethylenically unsaturated nitriles and amides, such as acrylonitrile, methacrylonitrile, acrylamide, methacrylamide, N,N-dimethyl acrylamide, N-dimethylaminomethyl)acryl-amide and the like, vinyl esters, such as vinyl acetate; vinyl ethers, vinyl ketones, vinyl and vinylidene halides, as well as a wide variety of other ethylenically unsaturated materials which are copolymerizable with the macromer, including mixture of any two or more thereof.

In some implementations, the reaction mixture used to form the pre-formed stabilizer used to produce the filled polyol composition comprises an ethylenically unsaturated monomer comprising a mixture of acrylonitrile and at least one other ethylenically unsaturated comonomer which is copolymerizable with acrylonitrile, such as, for example, styrene and its derivatives, acrylates, methacrylates, such as methyl methacrylate, vinylidene chloride, among others, as well as mixtures of any two or more thereof. When using acrylonitrile with a comonomer, it is sometimes desirable that a minimum of 5 to 15% by weight acrylonitrile be maintained in the system. One specific ethylenically unsaturated monomer mixture suitable for making the preformed stabilizer comprises mixtures of acrylonitrile and styrene in which, for example, acrylonitrile is used in an amount of 20 to 80% by weight, such as 30 to 70% by weight, based on the total weight of the monomer mixture, and styrene is used in an amount of 80 to 20% by weight, such as 70 to 30% by weight percent, based on the total weight of the monomer mixture.

In certain implementations, the ethylenically unsaturated compound is used in an amount of 10 to 30% by weight, such as 15 to 25% by weight, based on the total weight of the reaction mixture used to produce the pre-formed stabilizer.

The reaction mixture used to produce the pre-formed stabilizer, in certain implementations, also include a free radical initiator. Exemplary suitable free-radical initiators include peroxides, including both alkyl and aryl hydro-peroxides, persulfates, perborates, percarbonates, and azo compounds. Some specific examples include hydrogen peroxide, di(t-butyl)-peroxide, t-butylperoxy diethyl acetate, t-butyl peroctoate, t-butyl peroxy isobutyrate, t-butyl peroxy 3,5,5-trimethyl hexanoate, t-butyl perbenzoate, t-butyl peroxy pivalate, t-amyl peroxy pivalate, t-butyl peroxy-2-ethyl hexanoate, lauroyl peroxide, cumene hydroperoxide, t-butyl hydroperoxide, azobis(isobutyronitrile), and 2,2′-azo bis-(2-methylbutyronitrile). In some cases, the catalyst selected is one having a half-life that is 25 percent or less of the residence time in the reactor at a given temperature. Representative examples of useful initiators species include t-butyl peroxy-2-ethyl-hexanoate, t-butylperpivalate, t-amyl peroctoate, 2,5-dimethyl-hexane-2,5-di-per-2-ethyl hexoate, t-butylperneodecanoate, and t-butylperbenzoate, as well as azo compounds, such as azobis-isobutyronitrile, 2,2′-azo bis-(2-methylbutyro-nitrile), and mixtures thereof.

In some implementations, the free radical initiator is used in an amount of 0.01 to 2% by weight, such as 0.05 to 1% by weight or 0.05 to 0.3% by weight, based on the total weight of the reaction mixture used to produce the pre-formed stabilizer.

The reaction mixture used to produce the pre-formed stabilizer, in certain implementations, also include a polymer control agent. Suitable polymer control agents include various mono-ols (i.e. monohydroxy alcohols), aromatic hydrocarbons, and ethers. Specific examples of suitable polymer control agents are alcohols containing at least one carbon atom, such as methanol, ethanol, n-propanol, isopropanol, n-butanol, sec.-butanol, t-butanol, n-pentanol, 2-pentanol, 3-pentanol, and the like, and mixtures of any two or more thereof. Other suitable polymer control agents include ethylbenzene and toluene. The polymer control agent can be used in substantially pure form (i.e. as commercially available) or can be recovered in crude form from the polymer polyol production process and reused as-is. For instance, if the polymer control agent is isopropanol, it can be recovered from the polymer polyol process and used at any point in a subsequent product campaign in which the isopropanol is present.

In certain implementations, the polymer control agent is used in an amount of 30 to 80% by weight, such as 40 to 70% by weight, based on the total weight of the reaction mixture used to produce the pre-formed stabilizer.

As previously indicated, the reaction mixture used to produce the pre-formed stabilizer, in certain implementations, may also include a chain transfer agent. Suitable chain transfer agents include alkylene oxide adducts having a hydroxyl functionality of greater 3. In some implementations, the chain transfer agent is the same as or equivalent to the polyol used in the formation of precursor used to prepare the preformed stabilizer. In certain implementations, the chain transfer agent is used in an amount of 0 to 40% by weight, such as 0 to 20% by weight, or, in some cases, 0 to 10% by weight, based on the total weight of the reaction mixture used to produce the pre-formed stabilizer.

The preformed stabilizer can be produced by a process similar to that of making the polymer polyol. The temperature range is not critical and may vary from, for example, 80° C. to 150° C., such as 115° C. to 125° C. The mixing conditions employed can, for example, be those obtained using a back mixed reactor (e.g. —a stirred flask or stirred autoclave).

As indicated earlier, the reaction mixture used to produce certain implementations of the polymer polyol composition also comprises a free radical initiator, particular where the polymer particles are the free radical polymerization reaction product of an ethylenically unsaturated compound. Suitable such free-radical initiators include, for example, any of those described previously with respect to the production of the preformed stabilizer. In certain implementations, the free-radical initiator is present in the reaction mixture used to produce the polymer polyol composition in an amount of 0.01 to 2% by weight, based on 100% by weight of the final polymer polyol composition.

In some implementations, the reaction mixture used in preparing the polymer polyol composition further comprises a chain transfer agent. Examples of suitable chain transfer agents are mercaptans, such as dodecane thiol, ethane thiol, octane thiol, and toluene thiol, halogenated hydrocarbons, such as carbon tetrachloride, carbon tetrabromide, and chloroform, amines, such as diethylamine, and enol-ethers. In some embodiments, if used, the chain transfer agent is used in an amount of 0.1 to 2% by weight, such as 0.2 to 1% by weight, based on the total weight of the reaction mixture used to produce the polymer polyol.

According to the processes of this specification, a polymerizable composition, such as the ethylenically unsaturated compound in the reaction mixture described above, is reacted in the presence of an amine antioxidant, in which the amine antioxidant comprises a secondary diarylamine, a primary aromatic amide, a triazole, or a combination thereof

As indicated, in some implementations, the polymerizable composition is reacted in the presence of an amine antioxidant that comprises a secondary diarylamine. In some implementations, the secondary diarylamine has the structure:

R¹—NH—R²,

wherein R¹ and R² each independently represent a substituted or unsubstituted aryl group having 6 to 46 carbon atoms. Specific examples of suitable secondary diarylamines are, without limitation, diphenylamine, monoalkylated diphenylamine, dialkylated diphenylamine, trialkylated diphenylamine, 3-hydroxydiphenylamine, 4-hydroxydiphenylamine, mono- and/or di-butyldiphenylamine, mono- and/or di-octyldiphenylamine, mono- and/or di-nonyldiphenylamine, phenyl-α-naphthylamine, phenyl-β-naphthylamine, diheptyldiphenylamine, mono- and/or di-(α-methylstyryl)diphenylamine, mono- and/or distyryldiphenylamine, 4-(p-toluenesulfonamido)diphenylamine, 4-isopropoxydiphenylamine, t-octylated N-phenyl-1-naphthylamine, a mixture of mono- and dialkylated t-butyl-t-octyldiphenylamines, N-phenyl-1,2-phenylenediamine, N-phenyl-1,4-phenylenediamine, N,N′-diphenyl-p-phenylenediamine, N,N′-di(naphthyl-2)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, or a combination thereof.

In some implementations, the secondary diarylamine has the structure:

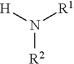

in which R¹ is C₁-C₁₈ alkyl, phenyl-C₁-C₄ alkyl, C₅-C₁₂ cycloalkyl, phenyl, or naphthyl, phenyl substituted by C₁-C₁₂ alkyl or C₁-C₁₂ alkoxy or benzyl or α,α-dimethylbenzyl, or phenyl substituted by C₁-C₁₂ alkyl or C₁-C₁₂ alkoxy or benzyl or α,α-dimethylbenzyl, and R² is phenyl, phenyl substituted by C₁-C₁₂ alkyl or C₁-C₁₂ alkoxy or benzyl or α,α-dimethylbenzyl, or naphthyl substituted by C₁-C₁₂ alkyl or C₁-C₁₂ alkoxy or benzyl or α,α-dimethylbenzyl.

As indicated, in some implementations, the polymerizable composition is reacted in the presence of an amine antioxidant that comprises a primary aromatic amide. As used herein, the term “primary aromatic amide” refers to a compound containing at least one primary amine group, at least one amide group, and at least one aromatic group. Specific examples of suitable primary aromatic amides include, without limitation, comprising benzamide, 2-aminobenzamide, 3-aminobenzamide, 4-aminobenzamide, benzene aminoamide (N-benzylurea), pyridine-3-carboxamide (nicotinamide), or a combination thereof.

As was also indicated, in some implementations, the polymerizable composition is reacted in the presence of an amine antioxidant that comprises a triazole. In some implementations, the triazole comprises a compound of formula (1), formula (2), formula (3), formula (4), or a combination thereof, in which:

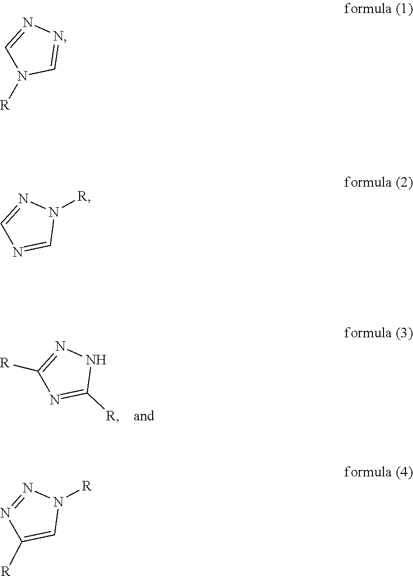

wherein, in each of formula (1), formula (2), formula (3), and formula (4), R represents: (a) hydrogen, or (b) a group comprising a primary amine, a secondary amine, a hydroxyl group, a thio group, or a combination thereof.

Specific examples of suitable triazoles include, without limitation, 1,2,4-triazole, 4-amino-1,2,4-triazole, 4-hydroxy-1,2,4-triazole, 1-amino-1,2,4-triazole, 1-mercapto-1,2,4-triazole, 1-hydroxy-1,2,4-triazole, 3-amino-1,2,4-triazole, 3-mercapto-1,2,4-triazole, 3-amino mercapto-1,2,4-triazole, 3-amino-5-methylthio-1,2,4-triazole, 1,2,3-triazole, 1-amino-1,2,3-triazole, 1-hydroxy-1,2,3-triazole, 1-mercapto-1,2,3-triazole, 1-mercapto-4-amino-1,2,3-triazole, or a combination thereof.

Of course, as should be appreciated, a combination of any two or more of the above-mentioned amine antioxidants may be used.

In some implementations, the amine antioxidant is used in an amount of at least 100 ppm, at least 200 ppm, or at least 300 ppm, and not more than 2500 ppm, no more than 1500 ppm by weight, not more than 1000 ppm, or, in some cases, no more than 500 ppm, based on the total weight of the filled polyol composition produced by the processes of this specification.

It was a surprising and unexpected discovery that, when producing a filled polyol composition, reacting the polymerizable composition, such as the ethylenically unsaturated compound in the reaction mixture described above, in the presence of an amine antioxidant of the type described above, resulted in a filled polyol composition of reduced viscosity (at the same solids content), as compared to the same filled polyol composition produced without the amine antioxidant. Moreover, as illustrated in the Examples below, it was observed that simply adding the amine antioxidant to the filled polyol composition after the polymerizable composition has reacted to produce the filled polyol did not result in any viscosity reduction. Therefore, it is believed that the processes of this specification, in which the polymerizable composition, such as the ethylenically unsaturated compound in the reaction mixture described above, is reacted in the presence of an amine antioxidant of the type described above, is critical to achieving the unexpected viscosity reduction described above.

The foregoing polymer polyol compositions can be made using any process (including continuous and semi-batch) and reactor configuration that is known to be suitable to prepare polymer polyols, such as, for example, a two-stage reaction system comprising a continuously-stirred tank reactor (CSTR) fitted with impeller(s) and baffles (first-stage) and a plug-flow reactor (second stage). Furthermore, the reaction system can utilize a wide range of mixing conditions. The reaction system may be characterized by energy inputs of from 0.5 to 350 horsepower per 1000 gallons, such as 2 to 50 horsepower per 1000 gallons on average for the bulk phase volume of each reactor as a particularly useful mixing power input. Mixing can be provided by any combination of impeller(s) and pump-around loop/jet mixing. In addition, such polymer polyols compositions can be prepared from various types and combinations of axially and/or radially/tangentially acting impellers including, but not limited to, 4-pitched-blade, 6-pitched-blade, 4-flat-blade, 6-flat-blade, pitched-blade turbine, flat-blade turbine, Rushton, Maxflow, propeller, etc. For a continuous production process to prepare polymer polyols, a residence time ranging of 20 to 180 minutes for the first reactor may be particularly useful.

In some implementations, the reactants are pumped from feed tanks through an in-line static mixer, and then, through a feed tube into the reactor. It may be particularly useful to prepare a premix of the initiator with part of the polyol stream, as well as of polyol and stabilizer. In general, feed stream temperatures are ambient (i.e. 25° C.). However, if desired, feed streams can be heated prior to mixing and entering the reactor. Other process conditions, which may be useful, include cooling of the feed tube in the reactor. Furthermore, the suitable reaction conditions for polymer polyols in general may be characterized by a reaction temperature in the range of 80 to 200° C. and a pressure in the range of 20 to 80 psig. Typically, the product can then treated in a single or multi staged stripping step to remove volatiles before entering a stage, which can essentially be any combination of filtration and/or product cooling.

In many cases, the polymer polyol compositions are produced by utilizing a low monomer to polyol ratio which is maintained throughout the reaction mixture during the process. This can be achieved by employing conditions that provide rapid conversion of monomer to polymer. In practice, a low monomer to polyol ratio is maintained, in the case of semi-batch and continuous operation, by control of the temperature and mixing conditions and, in the case of semibatch operation, also by slowly adding the monomers to the polyol. The temperature range is not critical and may vary from, for example, 80° C. to 200° C., 100° C. to 140° C., or, in some cases, 115° C. to 125° C.

One suitable continuous process for making polymer polyol compositions as described above comprises (1) providing a heterogenous mixture of the preformed stabilizer and, optionally, liquid diluent, in combination with a polyol, an amine antioxidant, a free radically polymerizable ethylenically unsaturated compound, and a free radical polymerization initiator, (2) in a reaction zone maintained at a temperature sufficient to initiate a free radical reaction, and under sufficient pressure to maintain only liquid phases in the reaction zone, for a period of time sufficient to react at least a major portion of the ethylenically unsaturated compound to form a heterogenous mixture containing the enhanced polymer polyol, unreacted monomers and diluent, and stripping the unreacted monomers and diluent from the enhanced polymer polyol to recover the unreacted monomers and diluent. When utilizing such a continuous process, it is preferred that the reactors be operated liquid-full (i.e. no appreciable free vapor space).

In some implementations, the polymer particles (whether individual particles or agglomerates of individual particles) are relatively small in size and, in some cases, have a weight average diameter less than ten microns.

Following polymerization, volatile constituents, in particular those from the PCA and residues of monomers are generally stripped from the product by, for example, vacuum distillation, such as in a thin layer of a falling film evaporator. The monomer-free product may be used as is, or may be filtered to remove any large particles that may have been created. In some cases, all of the product will pass through the filter employed in the 150 mesh filtration hindrance test.

Certain embodiments of this specification are directed to polyurethane foams produced using the filled polyol compositions produced as described above, as well to methods of manufacturing such polyurethane foam. As will be appreciated, polyurethane foams can be produced from reacting a reaction mixture comprising: (1) a polyisocyanate component and (2) an isocyanate-reactive component. The isocyanate-reactive component may comprise any of the filled polyol compositions produced as described above. In addition, the isocyanate-reactive component may include: (i) other polyols, such as a polyether polyol having a functionality of from 2 to 6, an OH number of from 18 to 238, and a number average molecular weight of from 160 to 8000, (ii) a blowing agent, (iii) a catalyst, and (iv) a surfactant.

Suitable blowing agents include halogenated hydrocarbons, halogenated olefins, water, liquid carbon dioxide, low boiling solvents such as, for example, pentane, and other known blowing agents. In some embodiments, the blowing agent comprises, or consists of, water. In certain implementations, blowing agent is used in an amount of 1 to 7 parts, such as 1 to 5 parts, by weight, based on the total weight of the isocyanate-reactive component.

Suitable catalysts include amine and tin based catalysts, such as diethylenetriamine, triethylenediamine, bis(2,2′-di-methylamino)ethyl ether, N,N,N′,N″,N″-pentamethyldiethylenetriamine, dibutyltin dilaurate, dibutyltin diacetate, and stannous octoate, and the like. In certain implementations, catalyst is used in an amount of 0.001 to 2 parts by weight, based on the total weight of the isocyanate-reactive component.

In addition, the isocyanate-reactive component may, if desired, include a low molecular weight chain extender and/or cross-linking agent which has a molecular weight of, for example, below 300 Da. Examples include, but are not limited to, glycerine, pentaerythritol, ethylene glycol, sorbitol, and alkanolamines, such as monoethanolamine, diethanolamine (DEOA) and triethanolamine (TEOA). In certain implementations, such chain extender and/or cross-linking agent is used in an amount of up to 5 parts per by weight, such as 0.4 to 3.5 parts by weight, based on the total weight of the isocyanate-reactive component.

Suitable surfactants include, but are not limited to, commercially available polyetherpolysiloxane foam stabilizers.

The polyurethane foam can be prepared by reacting the polyisocyanate component with the isocyanate-reactive component, wherein the polyisocyanate component is present in an amount sufficient to, for example, provide an isocyanate index of 70 to 130, such as 80 to 120 or 90 to 115.

The preparation of free rise foams typically entails mixing all components (except for the isocyanate components) together, then adding the isocyanate component to the mixture and briefly mixing. The mixture is then poured into a box and allowed to rise freely. Settling of the foam is measured, and it is oven cured at, for example, 125° C. for 5 minutes. After 16 hours at room temperature, shrinkage is noted and the foam properties can then be determined by various tests.

The preparation of molded foams typically involves pre-mixing the polyol components along with additives. The isocyanate component is then added to the pre-mix in a sufficient amount to the desired isocyanate index. The reaction mixture is then dispensed by hand or machine into a metal mold which is typically preheated to a temperature of 62 to 66° C. The reaction mixture foams to fill the mold and, after 4 to 5 minutes, the foam is removed from the mold and (physically) crushed to ensure that all cells were opened; and then aged for 2 hours.

Various aspects of the subject matter described herein are set out in the following numbered clauses:

Clause 1. A process for producing a filled polyol composition comprising a dispersion of polymer particles in a base polyol, the process comprising reacting a polymerizable composition in the presence of a composition comprising a base polyol and an amine antioxidant, wherein the amine antioxidant comprises a secondary diarylamine, a primary aromatic amide, a triazole, or a combination thereof.

Clause 2. The process of clause 1, wherein the filled polyol composition has a solids content of 30% by weight to 75% by weight, 35% by weight to 70% by weight, 40% by weight to 60% by weight, or 45% by weight to 55% by weight, based on the total weight of the filled polyol composition.

Clause 3. The process of clause 1 or clause 2, wherein the filled polyol composition has a viscosity of less than 50,000 mPas, less than 40,000 mPas, less than 30,000 mPas, less than 20,000 mPas or less than 10,000 mPas.

Clause 6. The process of one of clause 1 to clause 3, wherein the polymer particles comprise a polymer comprising the free radical polymerization reaction product of an ethylenically unsaturated compound, such as where the filled polyol composition comprises a reaction product of a reaction mixture comprising: (a) a base polyol having a functionality of 2 to 8 and a hydroxyl number of 20 to 400; (b) an ethylenically unsaturated compound, (c) a preformed stabilizer, and (d) a free radical initiator.

Clause 7. The process of one of clause 1 to clause 6, wherein the base polyol comprises a polyether polyol having a functionality of 2 to 8, 2 to 6 or 3 to 6, and an OH number of 20 to 400 mg KOH/g, 20 to 200 mg KOH/g, 20 to 150 mg KOH/g, 20 to 100 mg KOH/g, 20 to 50 mg KOH/g, 25 to 50 mg KOH/g, or 30 to 50 mg KOH/g.

Clause 8. The process of clause 7, wherein the base polyol comprises a polyoxyethylene glycol, a polyoxyethylene triol, a polyoxyethylene tetrol, a higher functionality polyoxyethylene polyol, a polyoxypropylene glycol, a polyoxypropylene triol, a polyoxypropylene tetrol, a higher functionality polypropylene polyol, or a mixture thereof, such as where the base polyol comprises internal blocks, terminal blocks or random distribution of the oxyethylene groups and/or oxypropylene groups in the polyether polyol.

Clause 9. The process of one of clause 6 to clause 8, wherein the ethylenically unsaturated compound comprises an aliphatic conjugated diene, such as butadiene and isoprene, a monovinylidene aromatic monomer, such as styrene, α-methyl-styrene, (t-butyl)styrene, chlorostyrene, cyanostyrene and bromostyrene, an α,β-ethylenically unsaturated carboxylic acids and/or ester thereof, such as acrylic acid, methacrylic acid, methyl methacrylate, ethyl acrylate, 2-hydroxyethyl acrylate, butyl acrylate, itaconic acid, and maleic anhydride, α,β-ethylenically unsaturated nitriles and amides, such as acrylonitrile, methacrylonitrile, acrylamide, methacrylamide, N,N-dimethyl acrylamide, and N-(dimethylaminomethyl)-acrylamide, vinyl esters, such as vinyl acetate, vinyl ethers, vinyl ketones, and vinyl and vinylidene halides.

Clause 10. The process of clause 9, wherein the ethylenically unsaturated compound comprises styrene and acrylonitrile, such as where styrene and acrylonitrile are used in sufficient amounts such that the weight ratio of styrene to acrylonitrile (S:AN) is within the range of 80:20 to 20:80 or 75:25 to 25:75.

Clause 11. The process of one of clause 6 to clause 10, wherein the pre-formed stabilizer comprises the reaction product of a reaction mixture comprising: (a) a macromer that contains reactive unsaturation, (b) an ethylenically unsaturated compound, (c) a free radical initiator, (d) a polymer control agent; and, in some cases, (e) a chain transfer agent.

Clause 12. The process of clause 11, wherein the macromer comprises the reaction product of a reaction mixture comprising: (i) an H-functional starter having a functionality of 2 to 8 and a hydroxyl number of 20 to 50; (ii) 0.1 to 3% by weight, based on 100% by weight of the sum of components (i), (ii) and (iii), of a hydroxyl-reactive compound that contains reactive unsaturation; and (iii) 0 to 3% by weight, 0.05 to 2.5% by weight, or 0.1 to 1.5% by weight, based on 100% by weight of the sum of components (i), (ii) and (iii), of a diisocyanate.

Clause 13. The process of one of clause 1 to clause 12, wherein the amine antioxidant comprises a secondary diarylamine having: wherein R¹ and R² each independently represent a substituted or unsubstituted aryl group having 6 to 46 carbon atoms.

Clause 14. The process of clause 13, wherein the secondary diarylamine comprises diphenylamine, monoalkylated diphenylamine, dialkylated diphenylamine, trialkylated diphenylamine, 3-hydroxydiphenylamine, 4-hydroxydiphenylamine, mono- and/or di-butyldiphenylamine, mono- and/or di-octyldiphenylamine, mono- and/or di-nonyldiphenylamine, phenyl-α-naphthylamine, phenyl-β-naphthylamine, diheptyldiphenylamine, mono- and/or di-(α-methylstyryl)diphenylamine, mono- and/or distyryldiphenylamine, 4-(p-toluenesulfonamido)diphenylamine, 4-isopropoxydiphenylamine, t-octylated N-phenyl-1-naphthylamine, a mixture of mono- and dialkylated t-butyl-t-octyldiphenylamines, N-phenyl-1,2-phenylenediamine, N-phenyl-1,4-phenylenediamine, N,N′-diphenyl-p-phenylenediamine, N,N′-di(naphthyl-2)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, or a combination thereof.

Clause 15. The process of one of clause 1 to clause 14, wherein the secondary diarylamine has the structure:

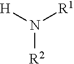

in which R¹ is C₁-C₁₈ alkyl, phenyl-C₁-C₄ alkyl, C₅-C₁₂ cycloalkyl, phenyl, or naphthyl, phenyl substituted by C₁-C₁₂ alkyl or C₁-C₁₂ alkoxy or benzyl or α,α-dimethylbenzyl, or phenyl substituted by C₁-C₁₂ alkyl or C₁-C₁₂ alkoxy or benzyl or α,α-dimethylbenzyl, and R² is phenyl, phenyl substituted by C₁-C₁₂ alkyl or C₁-C₁₂ alkoxy or benzyl or α,α-dimethylbenzyl, or naphthyl substituted by C₁-C₁₂ alkyl or C₁-C₁₂ alkoxy or benzyl or α,α-dimethylbenzyl.

Clause 16. The process of one of clause 1 to clause 15, wherein the amine antioxidant comprises a primary aromatic amide comprising benzamide, 2-aminobenzamide, 3-aminobenzamide, 4-aminobenzamide, benzene aminoamide (N-benzylurea), pyridine-3-carboxamide (nicotinamide), or a combination thereof.

Clause 17. The process of one of clause 1 to clause 16, wherein the amine antioxidant comprise a triazole comprising a compound of formula (1), formula (2), formula (3), formula (4), or a combination thereof, in which:

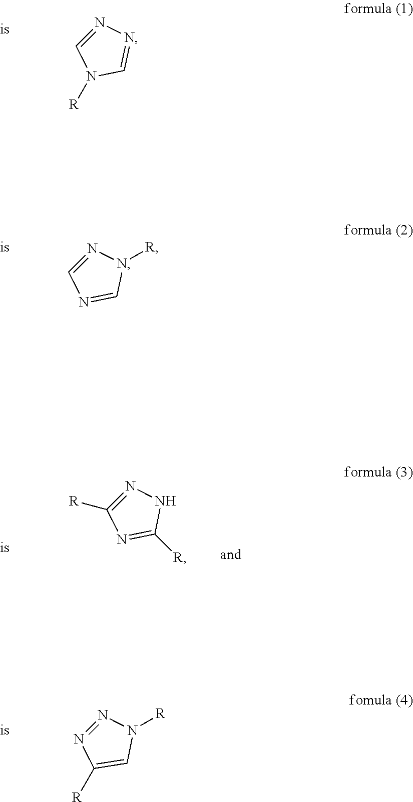

wherein, in each of formula (1), formula (2), formula (3), and formula (4), R represents: (a) hydrogen, or (b) a group comprising a primary amine, a secondary amine, a hydroxyl group, a thio group, or a combination thereof.

Clause 18. The process of clause 17, wherein the triazole comprises 1,2,4-triazole, 4-amino-1,2,4-triazole, 4-hydroxy-1,2,4-triazole, 1-amino-1,2,4-triazole, 1-mercapto-1,2,4-triazole, 1-hydroxy-1,2,4-triazole, 3-amino-1,2,4-triazole, 3-mercapto-1,2,4-triazole, 3-amino-5-mercapto-1,2,4-triazole, 3-amino-5-methylthio-1,2,4-triazole, 1,2,3-triazole, 1-amino-1,2,3-triazole, 1-hydroxy-1,2,3-triazole, 1-mercapto-1,2,3-triazole, 1-mercapto-4-amino-1,2,3-triazole, or a combination thereof.

Clause 19. The process of one of clause 1 to clause 18, wherein the amine antioxidant is used in an amount of at least 100 ppm, at least 200 ppm, or at least 300 ppm, and not more than 2500 ppm, no more than 1500 ppm by weight, not more than 1000 ppm, or, in some cases, no more than 500 ppm, based on the total weight of the filled polyol composition produced by the process.

Clause 20. A polyurethane foam produced using a filled polyol composition produced by the process of one of clause 1 to clause 19.

Clause 21. A process for preparing a filled polyol comprising free-radically polymerizing a reaction mixture comprising: (a) a base polyol having a functionality of from about 2 to about 8 and a hydroxyl number of from about 10 to about 1000 mg KOH/g; (b) an amine antioxidant comprising a secondary diarylamine, a primary aromatic amide, a triazole, or a combination thereof; (c) at least one preformed stabilizer; (d) an ethylenically unsaturated monomer; (e) a free radical polymerization catalyst and, optionally (f) a polymer control agent

Clause 22. The process of clause 21, wherein the filled polyol composition has a solids content of 30% by weight to 75% by weight, 35% by weight to 70% by weight, 40% by weight to 60% by weight, or 45% by weight to 55% by weight, based on the total weight of the filled polyol composition.

Clause 23. The process of clause 21 or clause 22, wherein the filled polyol composition has a viscosity of less than 50,000 mPas, less than 40,000 mPas, less than 30,000 mPas, less than 20,000 mPas or less than 10,000 mPas.

Clause 24. The process of one of clause 21 to clause 23, wherein the base polyol comprises a polyether polyol having a functionality of 2 to 8, 2 to 6 or 3 to 6, and an OH number of 20 to 400 mg KOH/g, 20 to 200 mg KOH/g, 20 to 150 mg KOH/g, 20 to 100 mg KOH/g, 20 to 50 mg KOH/g, 25 to 50 mg KOH/g, or 30 to 50 mg KOH/g.

Clause 25. The process of clause 24, wherein the base polyol comprises a polyoxyethylene glycol, a polyoxyethylene triol, a polyoxyethylene tetrol, a higher functionality polyoxyethylene polyol, a polyoxypropylene glycol, a polyoxypropylene triol, a polyoxypropylene tetrol, a higher functionality polypropylene polyol, or a mixture thereof, such as where the base polyol comprises internal blocks, terminal blocks or random distribution of the oxyethylene groups and/or oxypropylene groups in the polyether polyol.

Clause 26. The process of one of clause 21 to clause 25, wherein the ethylenically unsaturated compound comprises an aliphatic conjugated diene, such as butadiene and isoprene, a monovinylidene aromatic monomer, such as styrene, α-methyl-styrene, (t-butyl)styrene, chlorostyrene, cyanostyrene and bromostyrene, an α,β-ethylenically unsaturated carboxylic acids and/or ester thereof, such as acrylic acid, methacrylic acid, methyl methacrylate, ethyl acrylate, 2-hydroxyethyl acrylate, butyl acrylate, itaconic acid, and maleic anhydride, α,β-ethylenically unsaturated nitriles and amides, such as acrylonitrile, methacrylonitrile, acrylamide, methacrylamide, N,N-dimethyl acrylamide, and N-(dimethylaminomethyl)-acrylamide, vinyl esters, such as vinyl acetate, vinyl ethers, vinyl ketones, and vinyl and vinylidene halides.

Clause 27. The process of clause 26, wherein the ethylenically unsaturated compound comprises styrene and acrylonitrile, such as where styrene and acrylonitrile are used in sufficient amounts such that the weight ratio of styrene to acrylonitrile (S:AN) is within the range of 80:20 to 20:80 or 75:25 to 25:75.

Clause 28. The process of one of clause 21 to clause 27, wherein the pre-formed stabilizer comprises the reaction product of a reaction mixture comprising: (a) a macromer that contains reactive unsaturation, (b) an ethylenically unsaturated compound, (c) a free radical initiator, (d) a polymer control agent; and, in some cases, (e) a chain transfer agent.

Clause 29. The process of clause 28, wherein the macromer comprises the reaction product of a reaction mixture comprising: (i) an H-functional starter having a functionality of 2 to 8 and a hydroxyl number of 20 to 50; (ii) 0.1 to 3% by weight, based on 100% by weight of the sum of components (i), (ii) and (iii), of a hydroxyl-reactive compound that contains reactive unsaturation; and (iii) 0 to 3% by weight, 0.05 to 2.5% by weight, or 0.1 to 1.5% by weight, based on 100% by weight of the sum of components (i), (ii) and (iii), of a diisocyanate.

Clause 30. The process of one of clause 21 to clause 29, wherein the amine antioxidant comprises a secondary diarylamine having:

R¹—NH—R²,

wherein R¹ and R² each independently represent a substituted or unsubstituted aryl group having 6 to 46 carbon atoms.

Clause 31. The process of clause 30, wherein the secondary diarylamine comprises diphenylamine, monoalkylated diphenylamine, dialkylated diphenylamine, trialkylated diphenylamine, 3-hydroxydiphenylamine, 4-hydroxydiphenylamine, mono- and/or di-butyldiphenylamine, mono- and/or di-octyldiphenylamine, mono- and/or di-nonyldiphenylamine, phenyl-α-naphthylamine, phenyl-β-naphthylamine, diheptyldiphenylamine, mono- and/or di-(α-methylstyryl)diphenylamine, mono- and/or distyryldiphenylamine, 4-(p-toluenesulfonamido)diphenylamine, 4-isopropoxydiphenylamine, t-octylated N-phenyl-1-naphthylamine, a mixture of mono- and dialkylated t-butyl-t-octyldiphenylamines, N-phenyl-1,2-phenylenediamine, N-phenyl-1,4-phenylenediamine, N,N′-diphenyl-p-phenylenediamine, N,N′-di(naphthyl-2)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, or a combination thereof.

Clause 32. The process of one of clause 21 to clause 31, wherein the secondary diarylamine has the structure:

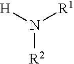

in which R¹ is C₁-C₁₈ alkyl, phenyl-C₁-C₄ alkyl, C₅-C₁₂ cycloalkyl, phenyl, or naphthyl, phenyl substituted by C₁-C₁₂ alkyl or C₁-C₁₂ alkoxy or benzyl or α,α-dimethylbenzyl, or phenyl substituted by C₁-C₁₂ alkyl or C₁-C₁₂ alkoxy or benzyl or α,α-dimethylbenzyl, and R² is phenyl, phenyl substituted by C₁-C₁₂ alkyl or C₁-C₁₂ alkoxy or benzyl or α,α-dimethylbenzyl, or naphthyl substituted by C₁-C₁₂ alkyl or C₁-C₁₂ alkoxy or benzyl or α,α-dimethylbenzyl.

Clause 33. The process of one of clause 21 to clause 32, wherein the amine antioxidant comprises a primary aromatic amide comprising benzamide, 2-aminobenzamide, 3-aminobenzamide, 4-aminobenzamide, benzene aminoamide (N-benzylurea), pyridine-3-carboxamide (nicotinamide), or a combination thereof.

Clause 34. The process of one of clause 21 to clause 33, wherein the amine antioxidant comprise a triazole comprising a compound of formula (1), formula (2), formula (3), formula (4), or a combination thereof, in which:

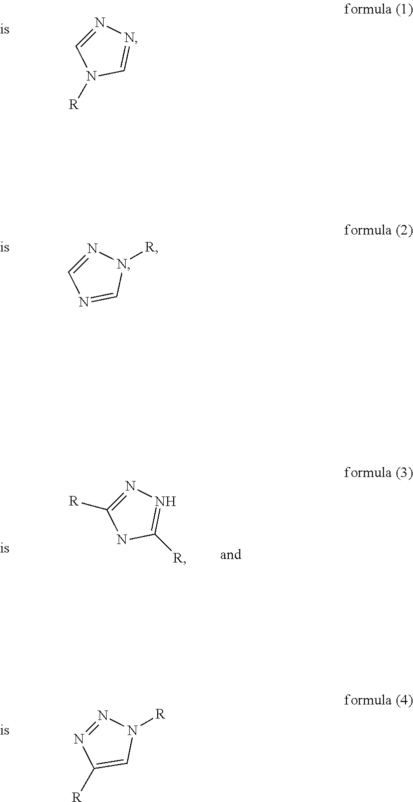

wherein, in each of formula (1), formula (2), formula (3), and formula (4), R represents: (a) hydrogen, or (b) a group comprising a primary amine, a secondary amine, a hydroxyl group, a thio group, or a combination thereof.

Clause 35. The process of clause 34, wherein the triazole comprises 1,2,4-triazole, 4-amino-1,2,4-triazole, 4-hydroxy-1,2,4-triazole, 1-amino-1,2,4-triazole, 1-mercapto-1,2,4-triazole, 1-hydroxy-1,2,4-triazole, 3-amino-1,2,4-triazole, 3-mercapto-1,2,4-triazole, 3-amino-5-mercapto-1,2,4-triazole, 3-amino-5-methylthio-1,2,4-triazole, 1,2,3-triazole, 1-amino-1,2,3-triazole, 1-hydroxy-1,2,3-triazole, 1-mercapto-1,2,3-triazole, 1-mercapto-4-amino-1,2,3-triazole, or a combination thereof.

Clause 36. The process of one of clause 21 to clause 35, wherein the amine antioxidant is used in an amount of at least 100 ppm, at least 200 ppm, or at least 300 ppm, and not more than 2500 ppm, no more than 1500 ppm by weight, not more than 1000 ppm, or, in some cases, no more than 500 ppm, based on the total weight of the filled polyol composition produced by the process.

Clause 37. A polyurethane foam produced using a filled polyol composition produced by the process of one of clause 21 to clause 36.

The non-limiting and non-exhaustive examples that follow are intended to further describe various non-limiting and non-exhaustive implementations without restricting the scope of the implementations described in this specification.

### EXAMPLES

The following components were used in the examples.
Polyol 1: A propylene oxide adduct of sorbitol containing 12% ethylene oxide as a cap with a hydroxyl number of 33.
Polyol 2: A propylene oxide adduct of glycerine containing a 20% ethylene oxide cap with a hydroxyl number of 36 and having a viscosity of 833 mPa·s.
PCA: Isopropanol, a polymer control agent.
MDI: Monomeric diphenylmethane diisocyanate (MDI) containing a high 2,4′-isomer content, available as Mondur® MLQ from Covestro LLC.
TMI: Isopropenyl dimethyl benzyl isocyanate (an unsaturated aliphatic isocyanate) sold as TMI° by Allnex.
Amine A: Anthranilamide, obtained from SigmaAldrich.
Amine B: N-Phenyl-p-phenylenediamine, obtained from SigmaAldrich.
Amine C: Irganox 5057, obtained from BASF Corporation.
Amine D: 3-Amino-1,2,4-triazole, obtained from TCI America.
Initiator A: tertiary-Butylperoxy-2-ethylhexanoate available as TBPEH from United initiators.
Initiator B: tertiary-Amyl peroxypivalate, a free-radical polymerization initiator commercially available as Trigonox 125-C75 from Nouryon.
Initiator C: 1,1-di(tert-amylperoxy)cyclohexane, a free-radical polymerization initiator, commercially available as Trigonox 122-C80 from Nouryon.
Catalyst A: Bismuth neodecanoate, commercially available under the name CosCat 83 from Vertellus.

### Test Methods

Viscosity: Dynamic viscosities reported in mPa·s and measured on an Anton-Paar SVM 3000 viscometer at 25° C. that has been demonstrated to give equivalent results as can be generated with ASTM-D4878-15. The instrument was calibrated using mineral oil reference standards of known viscosity.

Filtration: Filterability was determined by diluting one part by weight sample (e.g. 200 grams) of polymer polyol with two parts by weight anhydrous isopropanol (e.g. 400 grams) to remove any viscosity-imposed limitations and using a fixed quantity of material relative to a fixed cross-sectional area of screen (e.g. 1 ⅛ in. diameter), such that all of the polymer polyol and isopropanol solutions passes by gravity through a 700-mesh screen. The 700-mesh screen is made with a Dutch twill weave. The actual screen used had a nominal opening of 30 microns. The amount of sample which passed through the screen within 600 seconds was reported in percent, and a value of 100 percent indicates that over 99 weight percent passed through the screen.

### Macromer Preparation:

Macromer A: Polyol 1 (2783 g), TMI (16.9 g), and MDI (5.6 g) were added to a 12L flask and stirred at 75° C. for 2 hours. Catalyst A (100 ppm) was added and the reaction mixture was stirred an additional 2 hours at 75° C.

Preformed Stabilizer (pfs) Preparation:

The pre-formed stabilizer was prepared in a two-stage reaction system comprising a continuously-stirred tank reactor (CSTR) fitted with an impeller and 4 baffles (first-stage) and a plug-flow reactor (second stage). The residence time in each reactor was about 60 minutes. The reactants were pumped continuously to the reactor from feed tanks through an in-line static mixer and then through a feed tube into the reactor, which was well mixed. The temperature of the reaction mixture was controlled at 120±5° C. The product from the second-stage reactor overflowed continuously through a pressure regulator designed to control the pressure in each stage at 65 psig. The product, i.e. the pre-formed stabilizer, then passed through a cooler and into a collection vessel. The preformed stabilizer formulation is disclosed in Table 1.

TABLE 1

| Component | PFS |
|---|---|
| PCA, wt. % | 60.0% |
| Macromer A, wt. % | 24.0% |
| Monomer, wt. % | 15.9% |
| Styrene/acrylonitrile ratio | 50:50 |
| Initiator A, wt. % | 0.1% |

### Polymer Polyol Preparation

Table 2 relates to the preparation of the polymer polyol of the present specification. The polymer polyol was prepared in a two-stage reaction system comprising a continuously-stirred tank reactor (CSTR) fitted with an impeller and 4 baffles (first-stage) and a plug-flow reactor (second stage). The residence time in each reactor was about 60 minutes. The reactants were pumped continuously from feed tanks through an in-line static mixer and then through a feed tube into the reactor, which was well mixed. The temperature of the reaction mixture was controlled at 120±5° C. The product from the second-stage reactor overflowed continuously through a pressure regulator designed to control the pressure in each stage at 45 psig. The product, i.e. the polymer polyol, then passed through a cooler and into a collection vessel. The crude product was vacuum stripped to remove volatiles. The wt. % total polymer in the product was calculated from the concentrations of residual monomers measured in the crude polymer polyol before stripping.

TABLE 2

| | Comp | | | | |
|---|---|---|---|---|---|
| | Example 1 | Example 1 | Example 2 | Example 3 | Example 4 |
| Polyol | 2 | 2 | 2 | 2 | 2 |
| Polyol (wt. % in feed) | 49.41 | 49.37 | 49.37 | 49.37 | 49.37 |
| PFS (wt. % in feed) | 8.33 | 8.33 | 8.33 | 8.33 | 8.33 |
| Styrene (wt. % in feed) | 26.62 | 26.62 | 26.62 | 26.62 | 26.62 |
| Acrylonitrile | 15.38 | 15.38 | 15.38 | 15.38 | 15.38 |
| (wt. % in feed) | | | | | |
| Amine, (wt % in feed) | 0 | A (0.04) | B (0.04) | C (0.04) | D (0.04) |
| Initiator B/C | 0.25/0.015 | 0.25/0.015 | 0.25/0.015 | 0.25/0.015 | 0.25/0.015 |
| (wt. % in feed) | | | | | |
| Total Polymer (wt. %) | 44.7 | 44.3 | 44.0 | 44.4 | 45.1 |
| Viscosity | 6332 | 6169 | 5717 | 6190 | 5673 |
| mPa · s @ 25° C. | | | | | |
| Filterability, (seconds) | 257 | 238 | 227 | 235 | 245 |
| Viscosity | 4078 | 3976 | 3849 | 3627 | 2843 |
| mPa · s @ 25° C.* | | | | | |
| Viscosity Reduction, % | 0 | 2.5 | 5.6 | 11.1 | 30.3 |

*Diluted to 41% solids with Polyol 2

A 45% solids PMPO similar to Comparative Example 1 was used in the examples of Table 3. Amine (0.04 wt %) was added to each PMPO sample and then stored in a 60° C. oven for two hours. Upon cooling, the viscosity of the samples was measured, as detailed in Table 3. All viscosities were similar to the sample without added amine (Example 5). As is apparent, simply adding amine to the final PMPO did not have a beneficial effect on PMPO viscosity.

TABLE 3

| | Example 5* | Example 6* | Example 7* | Example 8* | Example 9* |
|---|---|---|---|---|---|
| Amine | — | A | B | C | D |
| Viscosity, | 5479 | 5476 | 5486 | 5468 | 5480 |
| mPa · s @ 25° C. | | | | | |

*comparative examples

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing a filled polyol composition comprising a dispersion of polymer particles in a base polyol, the process reacting a polymerizable composition in the presence of a composition comprising a base polyol and an amine antioxidant, in which the amine antioxidant comprises a secondary diarylamine, a primary aromatic amide, a triazole, or a combination thereof

2. The process of claim 1, wherein the amine antioxidant comprises a triazole of the formula (1), a triazole of the formula (2), a triazole of the formula (3), a triazole of the formula (4), or a combination thereof, wherein 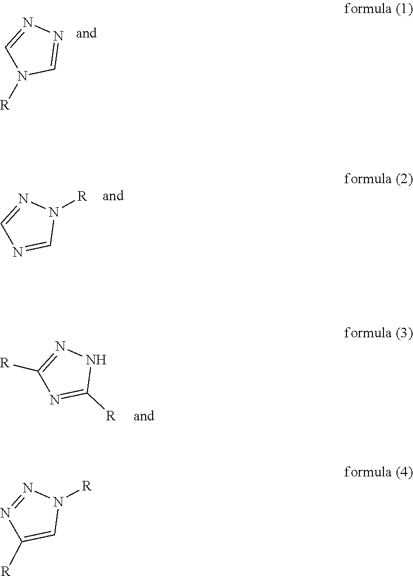
wherein R represents (a) hydrogen, or (b) a group comprising a primary amine, a secondary amine, a hydroxyl group, or a thio group.

3. The process of claim 1, wherein the amine antioxidant comprises a primary aromatic amide comprising benzamide, 2-aminobenzamide, 3-aminobenzamide, 4-aminobenzamide, benzene aminoamide (N-benzylurea), pyridine-3-carboxamide (nicotinamide), or a combination thereof.

4. The process of claim 1, wherein the amine antioxidant comprises a secondary diarylamine having the structure:
R¹—NH—R²,
wherein R¹ and R² each independently represent a substituted or unsubstituted aryl group having 6 to 46 carbon atoms.

5. The process of claim 1, wherein the secondary diarylamine has the structure: 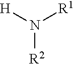
in which R¹ is C₁-C₁₈ alkyl, phenyl-C₁-C₄ alkyl, C₅-C₁₂ cycloalkyl, phenyl, or naphthyl, phenyl substituted by C₁-C₁₂ alkyl or C₁-C₁₂ alkoxy or benzyl or α,α-dimethylbenzyl, or phenyl substituted by C₁-C₁₂ alkyl or C₁-C₁₂ alkoxy or benzyl or α,α-dimethylbenzyl, and R² is phenyl, phenyl substituted by C₁-C₁₂ alkyl or C₁-C₁₂ alkoxy or benzyl or α,α-dimethylbenzyl, or naphthyl substituted by C₁-C₁₂ alkyl or C₁-C₁₂ alkoxy or benzyl or α,α-dimethylbenzyl.

6. The process of claim 1, wherein the polymerizable composition comprises a free radical polymerizable composition comprising an ethylenically unsaturated compound comprising styrene and acrylonitrile.

7. The process of claim 1, wherein the amine antioxidant is present in an amount of 100 to 2000 ppm, based on the total weight of the filled polyol composition.

8. A process of making a polyurethane foam comprising reacting, at an isocyanate index of 70 to 130, a reaction mixture comprising: (1) a polyisocyanate component and (2) an isocyanate-reactive component comprising a filled polyol composition prepared by the process of claim 1.

9. The process of claim 8, wherein the isocyanate-reactive component further comprises a blowing agent, a catalyst, and a surfactant.

10. A polyurethane foam produced by the process of claim 8.

11. A process for preparing a polymer polyol comprising free-radically polymerizing a reaction mixture comprising:
(a) a base polyol having a functionality of 2 to 8 and a hydroxyl number of 10 to 1000 mg KOH/g;
(b) an amine antioxidant comprising a secondary diarylamine, a primary aromatic amide, a triazole, or a combination thereof;
(c) at least one preformed stabilizer;
(d) an ethylenically unsaturated monomer; and
(e) a free radical polymerization catalyst and, optionally
(f) a polymer control agent

12. The process of claim 11, wherein the amine antioxidant comprises a triazole of the formula (1), a triazole of the formula (2),), a triazole of the formula (3), a triazole of the formula (4), or a combination thereof, wherein 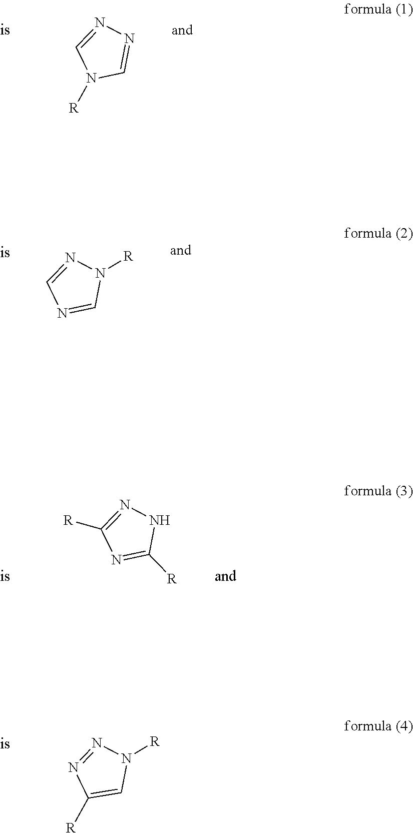
wherein R represents (a) hydrogen, or (b) a group comprising a primary amine, a secondary amine, a hydroxyl group, or a thio group.

13. The process of claim 11, wherein the amine antioxidant comprises a primary aromatic amide comprising benzamide, 2-aminobenzamide, 4-aminobenzamide, benzene aminoamide (N-benzylurea), pyridine-3-carboxamide (nicotinamide), or a combination thereof.

14. The process of claim 11, wherein the amine antioxidant comprises a secondary diarylamine having the structure:
R¹—NH—R²,
wherein R¹ and R² each independently represent a substituted or unsubstituted aryl group having 6 to 46 carbon atoms.

15. The process of claim 11, wherein the secondary diarylamine has the structure: 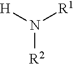
in which R¹ is C₁-C₁₈ alkyl, phenyl-C₁-C₄ alkyl, C₅-C₁₂ cycloalkyl, phenyl, or naphthyl, phenyl substituted by C₁-C₁₂ alkyl or C₁-C₁₂ alkoxy or benzyl or α,α-dimethylbenzyl, or phenyl substituted by C₁-C₁₂ alkyl or C₁-C₁₂ alkoxy or benzyl or α,α-dimethylbenzyl, and R² is phenyl, phenyl substituted by C₁-C₁₂ alkyl or C₁-C₁₂ alkoxy or benzyl or α,α-dimethylbenzyl, or naphthyl substituted by C₁-C₁₂ alkyl or C₁-C₁₂ alkoxy or benzyl or α,α-dimethylbenzyl.

16. The process of claim 11, wherein the amine antioxidant is present in an amount of 100 to 2000 ppm, based on the total weight of the reaction mixture.

17. The process of claim 11, wherein the ethylenically unsaturated monomer comprises styrene and acrylonitrile.

18. A process of making a polyurethane foam comprising reacting, at an isocyanate index of 70 to 130, a reaction mixture comprising: (1) a polyisocyanate component and (2) an isocyanate-reactive component comprising a filled polyol composition prepared by the process of claim 11.

19. The process of claim 18, wherein the isocyanate-reactive component further comprises a blowing agent, a catalyst, and a surfactant.

20. A polyurethane foam produced by the process of claim 18.
